(19) United States
(12) Patent Application Publication
(10) Pub. No.: US 2015/0121316 A1
(43) Pub. Date: Apr. 30, 2015

(54) METHOD FOR UNLOCKING TOUCH-SENSITIVE DEVICE, AND TOUCH-SENSITIVE DEVICE

(71) Applicant: Huawei Technologies Co., Ltd., Shenzhen (CN)

(72) Inventor: Hai Chang, Shenzhen (CN)

(21) Appl. No.: 14/587,648

(22) Filed: Dec. 31, 2014

Related U.S. Application Data
(63) Continuation of application No. PCT/CN2013/074396, filed on Apr. 19, 2013.

(30) Foreign Application Priority Data
Oct. 12, 2012 (CN) 201210387317.6

(51) Int. Cl. G06F 3/0488

(52) U.S. Cl. CPC G06F 3/0488
USPC 715/863

(57) ABSTRACT

Embodiments of the invention disclose a method for unlocking a touch-sensitive device and a touch-sensitive device, which resolves a problem that a user always performs unlocking by inputting a default password or by using a default preset graphical interaction interface of the touch-sensitive device, which is monotonous and uninteresting. The method includes: receiving, by the touch-sensitive device, a second unlocking manner input by a user; and unlocking itself by the touch-sensitive device if the second unlocking manner is the same as a first unlocking manner, where the first unlocking manner is preset by the user according to an unlocking feature, and the unlocking feature is position-related and is preset by the user. The present invention is applicable to unlocking a touch-sensitive device having a touchscreen, such as a touchscreen mobile phone or a tablet computer.

### CROSS-REFERENCE TO RELATED APPLICATION

This application is a continuation of International Application No. PCT/CN2013/074396, filed on Apr. 19, 2013, which claims priority to Chinese Patent Application No. 201210387317.6, filed on Oct. 12, 2012, both of which are hereby incorporated by reference in their entireties.

### TECHNICAL FIELD

The present invention relates to the field of communications technologies, and in particular, to a method for unlocking a touch-sensitive device, and the touch-sensitive device.

### BACKGROUND

At present, a touch-sensitive device is widely used as an easy-to-use input device, and is applied in, for example, fields such as a touchscreen mobile phone and a tablet computer. Because a touch-sensitive device is usually put at a place that a user can easily touch, for example, in a handbag or a pocket, some misoperations are prone to be performed before the touch-sensitive device is used, and consequently the touch-sensitive device is activated unexpectedly, thereby some functions are triggered. For example, an operation of powering on or powering off the touch-sensitive device is performed, or a call function is triggered to call a person. Therefore, all existing touch-sensitive devices have a screen lock function to avoid the foregoing misoperations. At present, after being locked, a touch-sensitive device needs to be unlocked before it is used again. A plurality of unlocking manners is available. A common manner is performing unlocking by using a default preset graphical interaction interface of the touch-sensitive device, where the user performs unlocking by sliding along a fixed track or by sliding along a preset track on a pattern such as a nine-square grid, or performs unlocking by performing an operation on a sign to control the sign to enter a preset area. In addition, among the unlocking manners, there is also a manner of performing unlocking by directly inputting a default password.

During the implementation of embodiments of the present invention, the inventor finds that the prior art has at least the following problem:

At present, a touch-sensitive device generally has only one or several unlocking manners, and a user always performs unlocking by inputting a default password or by using a default preset graphical interaction interface of a touch-sensitive device, which is monotonous and uninteresting.

### SUMMARY

Embodiments of the present invention provide a method for unlocking a touch-sensitive device, and a touch-sensitive device, which can resolve a problem in the prior art that a touch-sensitive device generally has only one or several unlocking manners, and that a user always performs unlocking by inputting a default password or by using a default preset graphical interaction interface, which is monotonous and uninteresting.

To achieve the foregoing objectives, the present invention uses the following technical solutions:

According to a first aspect, a method for unlocking a touch-sensitive device provided by an embodiment of the present invention includes:

receiving, by the touch-sensitive device, a second unlocking manner input by a user; and

unlocking itself by the touch-sensitive device if the second unlocking manner is the same as a first unlocking manner, where the first unlocking manner is preset by the user according to an unlocking feature, and the unlocking feature is position-related and is preset by the user.

With reference to the first aspect, in a first implementation manner of the first aspect, that the unlocking feature is position-related includes that:

the unlocking feature is a first unlocking point preset by the user at one or more corners of a screen according to a shape of the screen of the touch-sensitive device, where each corner of the one or more corners is corresponding to one first unlocking point; and

the first unlocking manner is tapping one or more of the preset first unlocking points.

With reference to the first implementation manner of the first aspect, in a second implementation manner of the first aspect, before the receiving, by the touch-sensitive device, a second unlocking manner input by a user, the method includes:

receiving, by the touch-sensitive device, an unlock trigger instruction input by the user;

invoking, by the touch-sensitive device within predetermined duration, a first feature value of the preset first unlocking point after the unlock trigger instruction is received, where the first feature value is position coordinates of the first unlocking point on the screen; and

if the first feature value is invoked successfully within the predetermined duration, invoking, by the touch-sensitive device, the first unlocking manner.

With reference to the second implementation manner of the first aspect, in a third implementation manner of the first aspect, the method further includes:

if the first feature value is not invoked successfully within the predetermined duration, invoking, by the touch-sensitive device, another unlocking manner that is preset in the touch-sensitive device and that is other than the first unlocking manner, so that the touch-sensitive device unlocks itself if the second unlocking manner is the same as the another unlocking manner.

With reference to the first aspect, in a fourth implementation manner of the first aspect, that the unlocking feature is position-related includes that:

the unlocking feature is one or more second unlocking points or one first unlocking path, which is preset by the user on an image feature according to the image feature on a background picture, where the background picture is imported in advance by the user to serve as a screen background of the touch-sensitive device; and

the first unlocking manner is tapping the one or more second unlocking points, or drawing a track by sliding along the first unlocking path.

With reference to the fourth implementation manner of the first aspect, in a fifth implementation manner of the first aspect, before the receiving, by the touch-sensitive device, a second unlocking manner input by a user, the method includes:

receiving, by the touch-sensitive device, an unlock trigger instruction input by the user;

invoking, by the touch-sensitive device within predetermined duration, a second feature value of the preset second unlocking point or a third feature value of the first unlocking path after the unlock trigger instruction is received, where the second feature value is position coordinates of the second unlocking point on the background picture, and the third feature value is position coordinates of points through which the first unlocking path passes on the background picture; and

if the second feature value or the third feature value is invoked successfully within the predetermined duration, displaying the background picture and invoking the first unlocking manner by the touch-sensitive device.

With reference to the fifth implementation manner of the first aspect, in a sixth implementation manner of the first aspect, the method further includes:

if neither the second feature value nor the third feature value is invoked successfully within the predetermined duration, invoking, by the touch-sensitive device, another unlocking manner that is preset in the touch-sensitive device and that is other than the first unlocking manner, so that the touch-sensitive device unlocks itself if the second unlocking manner is the same as the another unlocking manner.

According to a second aspect, a touch-sensitive device provided by an embodiment of the present invention includes:

a first receiving unit, configured to receive a second unlocking manner input by a user; and

an unlock processing unit, configured to unlock the touch-sensitive device if the second unlocking manner received by the first receiving unit is the same as a first unlocking manner, where the first unlocking manner is preset by the user according to an unlocking feature, and the unlocking feature is position-related and is preset by the user.

With reference to the second aspect, in a first implementation manner of the second aspect, that the unlocking feature is position-related includes that:

the unlocking feature is a first unlocking point preset by the user at one or more corners of a screen according to a shape of the screen of the touch-sensitive device, where each corner of the one or more corners is corresponding to one first unlocking point; and

the first unlocking manner is tapping one or more of the preset first unlocking points.

With reference to the first implementation manner of the second aspect, in a second implementation manner of the second aspect, the touch-sensitive device further includes:

a second receiving unit, configured to receive an unlock trigger instruction input by the user; and

a first invoking unit, configured to invoke a first feature value of the preset first unlocking point within predetermined duration after the second receiving unit receives the unlock trigger instruction, where the first feature value is position coordinates of the first unlocking point on the screen; and

the first invoking unit is further configured to invoke the first unlocking manner if the first feature value is invoked successfully within the predetermined duration.

With reference to the second implementation manner of the second aspect, in a third implementation manner of the second aspect, the first invoking unit is further configured to:

if the first feature value is not invoked successfully within the predetermined duration, invoke another unlocking manner that is preset in the touch-sensitive device and that is other than the first unlocking manner, so that the touch-sensitive device unlocks itself if the second unlocking manner is the same as the another unlocking manner.

With reference to the second aspect, in a fourth implementation manner of the second aspect, that the unlocking feature is position-related includes that:

the unlocking feature is one or more second unlocking points or one first unlocking path, which is preset by the user on an image feature according to the image feature on a background picture, where the background picture is imported in advance by the user to serve as a screen background of the touch-sensitive device; and

the first unlocking manner is tapping the one or more second unlocking points, or drawing a track by sliding along the first unlocking path.

With reference to the fourth implementation manner of the second aspect, in a fifth implementation manner of the second aspect, the touch-sensitive device further includes:

a third receiving unit, configured to receive an unlock trigger instruction input by the user; and

a second invoking unit, configured to invoke a second feature value of the preset second unlocking point or a third feature value of the first unlocking path within predetermined duration after the unlock trigger instruction is received, where the second feature value is position coordinates of the second unlocking point on the background picture, and the third feature value is position coordinates of points through which the first unlocking path passes on the background picture, and

the second invoking unit is further configured to: if the second feature value or the third feature value is invoked successfully within the predetermined duration, display the background picture and invoke the first unlocking manner.

With reference to the fifth implementation manner of the second aspect, in a sixth implementation manner of the second aspect, the second invoking unit is further configured to:

if neither the second feature value nor the third feature value is invoked successfully within the predetermined duration, invoke another unlocking manner that is preset in the touch-sensitive device and that is other than the first unlocking manner, so that the touch-sensitive device unlocks itself if the second unlocking manner is the same as the another unlocking manner.

According to a method for unlocking a touch-sensitive device, and a touch-sensitive device provided by the embodiments of the present invention, the touch-sensitive device receives a second unlocking manner input by a user; and the touch-sensitive device unlocks itself if the second unlocking manner is the same as a first unlocking manner. Because the first unlocking manner is preset by the user according to an unlocking feature, and the unlocking feature is position-related and is preset by the user, the unlocking feature may be updated according to a requirement of the user, so as to avoid a problem that the user always performs unlocking by inputting a default password or by using a default preset graphical interaction interface, which is monotonous and uninteresting.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a method for unlocking a touch-sensitive device according to an embodiment of the present invention;

FIG. 2 is a flowchart of a method for unlocking a touch-sensitive device according to another embodiment of the present invention;

FIG. 3 is a flowchart of a method for unlocking a touch-sensitive device according to still another embodiment of the present invention;

FIG. 4 is a first schematic structural diagram of a touch-sensitive device according to an embodiment of the present invention;

FIG. 5 is a second schematic structural diagram of a touch-sensitive device according to an embodiment of the present invention;

FIG. 6 is a third schematic structural diagram of a touch-sensitive device according to an embodiment of the present invention; and

FIG. 7 is a schematic structural diagram of a touch-sensitive device according to another embodiment of the present invention.

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

To make the advantages of the technical solutions of the present invention clearer, the following describes the present invention in detail with reference to the accompanying drawings and the embodiments.

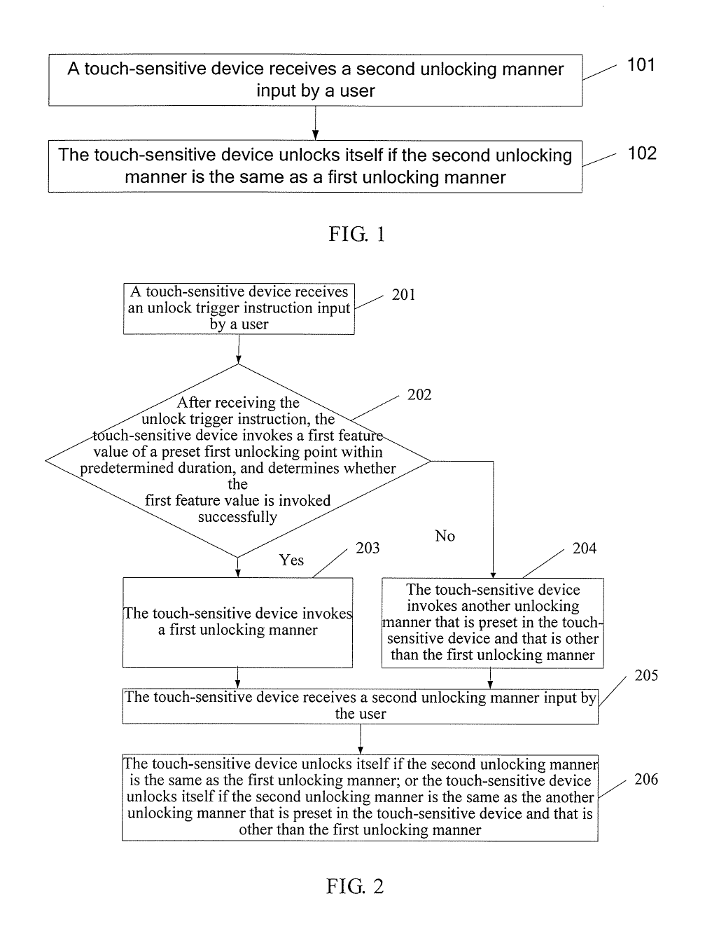

As shown in FIG. 1, a method for unlocking a touch-sensitive device provided by an embodiment of the present invention includes the following:

101. The touch-sensitive device receives a second unlocking manner input by a user.

102. The touch-sensitive device unlocks itself if the second unlocking manner is the same as a first unlocking manner.

The first unlocking manner is preset by the user according to an unlocking feature, and the unlocking feature is position-related and is preset by the user.

That the unlocking feature is position-related includes that: the unlocking feature is a first unlocking point preset by the user at one or more corners of a screen according to a shape of the screen of the touch-sensitive device, where each corner of the one or more corners is corresponding to one first unlocking point; in this case, the first unlocking manner is tapping one or more of the preset first unlocking points.

Alternatively, the unlocking feature is one or more second unlocking points or one first unlocking path, which is preset by the user on an image feature according to the image feature on a background picture, where the background picture is imported in advance by the user to serve as a screen background of the touch-sensitive device; in this case, the first unlocking manner is tapping the one or more second unlocking points, or drawing a track by sliding along the first unlocking path. For example, the user sets a picture of a cat, and specifies that two points at the two ears of the cat are used for unlocking; accordingly, the two points at the two ears are the unlocking features. The first unlocking manner may be tapping the two points at the two ears separately, or sliding from one point to the other point, but is not limited thereto. Other unlocking features that are preset by the user and are position-related and the first unlocking manner shall fall within the protection scope of the present invention.

According to a method for unlocking a touch-sensitive device provided by this embodiment of the present invention, the touch-sensitive device receives a second unlocking manner input by a user; and the touch-sensitive device unlocks itself if the second unlocking manner is the same as a first unlocking manner. Because the first unlocking manner is preset by the user according to an unlocking feature, and the unlocking feature is position-related and is preset by the user, the unlocking feature may be updated according to a requirement of the user, so as to avoid a problem that the user always performs unlocking by inputting a default password or by using a default preset graphical interaction interface, which is monotonous and uninteresting.

As shown in FIG. 2, FIG. 2 is a flowchart of a method for unlocking a touch-sensitive device according to another embodiment of the present invention, where a first unlocking manner is preset by a user according to an unlocking feature, and the unlocking feature is a first unlocking point preset by the user at one or more corners of a screen according to a shape of the screen of the touch-sensitive device, where each corner of the one or more corners is corresponding to one first unlocking point, and the first unlocking manner is tapping one or more of the preset first unlocking points. The method includes the following:

201. The touch-sensitive device receives an unlock trigger instruction input by the user.

Specifically, the unlock trigger instruction may be a key signal that is input by the user and received by the touch-sensitive device (that is, the user taps a key on the touch-sensitive device), but is not limited thereto.

202. After receiving the unlock trigger instruction, the touch-sensitive device invokes a first feature value of the preset first unlocking point within predetermined duration, and determines whether the first feature value is invoked successfully.

The first feature value is position coordinates of the first unlocking point on the screen.

That invoking a first feature value of the preset first unlocking point is used to determine whether the first unlocking point corresponding to the first feature value is available.

If the first feature value is invoked successfully within the predetermined duration, step 203 is executed; otherwise, if the first feature value is not invoked successfully within the predetermined duration, step 204 is executed.

The touch-sensitive device invokes the first unlocking manner.

204. The touch-sensitive device invokes another unlocking manner that is preset in the touch-sensitive device and that is other than the first unlocking manner.

Specifically, if the first feature value is not invoked successfully within the predetermined duration, it indicates that the first unlocking point corresponding to the first feature value is unavailable. Accordingly, the touch-sensitive device may invoke the another unlocking manner that is preset in the touch-sensitive device and that is other than the first unlocking manner, where the another unlocking manner that is preset in the touch-sensitive device and that is other than the first unlocking manner may be an unlocking manner that is set according to an unlocking feature and previously used by the user, and may also be a default unlocking manner in the system of the touch-sensitive device (for example, a nine-square grid unlocking manner in the Android system), but is not limited thereto.

205. The touch-sensitive device receives a second unlocking manner input by the user.

Specifically, the user inputs the second unlocking manner by touching the touch-sensitive device, for example, by touching an unlocking point on the screen of the touch-sensitive device.

206. The touch-sensitive device unlocks itself if the second unlocking manner is the same as the first unlocking manner; or the touch-sensitive device unlocks itself if the second unlocking manner is the same as the another unlocking manner that is preset in the touch-sensitive device and that is other than the first unlocking manner.

For example, the first unlocking manner is touching four preset first unlocking points at four corners on the touch-sensitive device, whereas the second unlocking manner is that, the touch-sensitive device unlocks itself if the user touches the four preset first unlocking points at the four corners on the touch-sensitive device.

According to a method for unlocking a touch-sensitive device provided by another embodiment of the present invention, the touch-sensitive device receives a second unlocking manner input by a user; and the touch-sensitive device unlocks itself if the second unlocking manner is the same as a first unlocking manner. Because the first unlocking manner is preset by the user according to an unlocking feature, and the unlocking feature is position-related and is preset by the user, the unlocking feature may be updated according to a requirement of the user, so as to avoid a problem that the user always performs unlocking by inputting a default password or by using a default preset graphical interaction interface, which is monotonous and uninteresting.

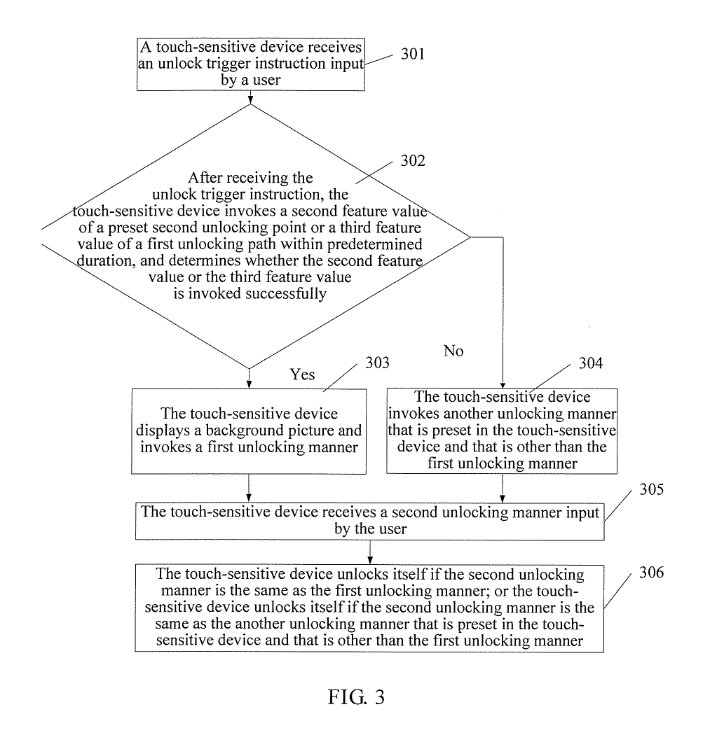

As shown in FIG. 3, FIG. 3 is a flowchart of a method for unlocking a touch-sensitive device according to still another embodiment of the present invention, where a first unlocking manner is preset by a user according to an unlocking feature, the unlocking feature is one or more second unlocking points or one first unlocking path, which is preset by the user on an image feature according to the image feature on a background picture, and the background picture is imported in advance by the user to serve as a screen background of the touch-sensitive device. The method includes the following:

301. The touch-sensitive device receives an unlock trigger instruction input by the user.

Specifically, the unlock trigger instruction may be a key signal that is input by the user and received by the touch-sensitive device (that is, the user taps a key on the touch-sensitive device), but is not limited thereto.

302. After receiving the unlock trigger instruction, the touch-sensitive device invokes a second feature value of the preset second unlocking point or a third feature value of the first unlocking path within predetermined duration, and determines whether the second feature value or the third feature value is invoked successfully.

The second feature value is position coordinates of the second unlocking point on the background picture, and the third feature value is position coordinates of points through which the first unlocking path passes on the background picture.

For example, the user sets a cat picture as the background picture, and specifies that two points at the two ears of the cat are used for unlocking; accordingly, the two points at the two ears are two second unlocking points. The first unlocking manner is an unlocking manner set according to the unlocking feature by the user on the touch-sensitive device. For example, the two points at the two ears are the second unlocking points; accordingly, tapping the two points at the two ears separately or sliding from one point to the other point is used as the first unlocking manner, which is not limited thereto. Other first unlocking manners that are preset by the user by using a background picture imported by the user and are received by the touch-sensitive device shall fall within the protection scope of the present invention.

That invoking the second feature value of the preset second unlocking point or the third feature value of the first unlocking path is used to determine whether the second unlocking point or the first unlocking path is available.

If the second feature value or the third feature value is invoked successfully within the predetermined duration, step 303 is executed; otherwise, if neither the second feature value nor the third feature value is invoked successfully within the predetermined duration, step 304 is executed.

The touch-sensitive device displays the background picture and invokes the first unlocking manner.

That the touch-sensitive device invokes the first unlocking manner may be finding, by using the background picture, the second unlocking point or the first unlocking path the user needs by means of presenting the background picture on a screen.

The touch-sensitive device invokes another unlocking manner that is preset in the touch-sensitive device and that is other than the first unlocking manner.

Specifically, if neither the second feature value nor the third feature value is invoked success fully within the predetermined duration, it indicates that neither the second unlocking point corresponding to the second feature value nor the first unlocking path corresponding to the third feature value is available. Accordingly, the touch-sensitive device may invoke the another unlocking manner that is preset in the touch-sensitive device and that is other than the first unlocking manner, where the another unlocking manner that is preset in the touch-sensitive device and that is other than the first unlocking manner may be an unlocking manner that is set according to an unlocking feature and previously used by the user, and may also be a default unlocking manner in the system of the touch-sensitive device (for example, a nine-square grid unlocking manner in the Android system), but is not limited thereto.

305. The touch-sensitive device receives a second unlocking manner input by the user.

Specifically, the user inputs the second unlocking manner by touching the touch-sensitive device, for example, by touching the second unlocking point or the first unlocking path on the screen of the touch-sensitive device.

306. The touch-sensitive device unlocks itself if the second unlocking manner is the same as the first unlocking manner; or the touch-sensitive device unlocks itself if the second unlocking manner is the same as the another unlocking manner that is preset in the touch-sensitive device and that is other than the first unlocking manner.

For example, the first unlocking manner is touching two unlocking points which are preset at the two ears of a cat on the background picture of the touch-sensitive device, whereas the second unlocking manner is that, the touch-sensitive device unlocks itself if the user touches the two unlocking points which are preset at the two ears of the cat on the background picture of the touch-sensitive device.

According to a method for unlocking a touch-sensitive device provided in still another embodiment of the present invention, the touch-sensitive device receives a second unlocking manner input by a user; and the touch-sensitive device unlocks itself if the second unlocking manner is the same as a first unlocking manner. Because the first unlocking manner is preset by the user according to an unlocking feature, and the unlocking feature is position-related and is preset by the user, the unlocking feature may be updated according to a requirement of the user, so as to avoid a problem that the user always performs unlocking by inputting a default password or by using a default preset graphical interaction interface, which is monotonous and uninteresting.

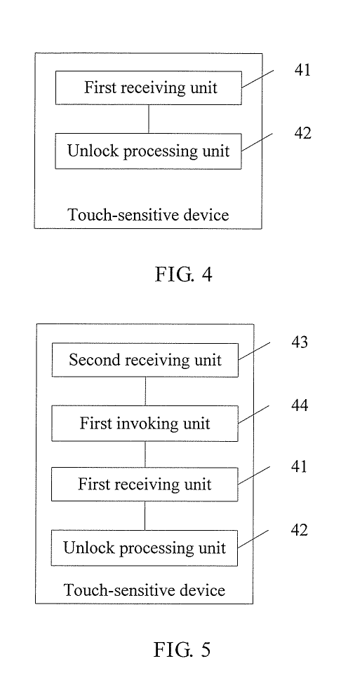

As shown in FIG. 4, a touch-sensitive device provided by an embodiment of the present invention includes a first receiving unit 41 and an unlock processing unit 42.

The first receiving unit 41 is configured to receive a second unlocking manner input by a user. For a specific implementation manner, refer to step 101 in FIG. 1, which is not described herein again.

The unlock processing unit 42 is configured to unlock the touch-sensitive device if the second unlocking manner received by the first receiving unit 41 is the same as a first unlocking manner. For a specific implementation manner, refer to step 102 in FIG. 1, which is not described herein again.

The first unlocking manner is preset by the user according to an unlocking feature, and the unlocking feature is position-related and is preset by the user. For a specific implementation manner, refer to step 102 in FIG. 1, which is not described herein again.

Optionally, that the unlocking feature is position-related includes that:
the unlocking feature is a first unlocking point preset by the user at one or more corners of a screen according to a shape of the screen of the touch-sensitive device, where each corner of the one or more corners is corresponding to one first unlocking point.

The first unlocking manner is tapping one or more of the preset first unlocking points.

Further, as shown in FIG. 5, the touch-sensitive device further includes a second receiving unit 43 and a first invoking unit 44.

The second receiving unit 43 is configured to receive an unlock trigger instruction input by the user. For a specific implementation manner, refer to step 201 in FIG. 2, which is not described herein again.

The first invoking unit 44 is configured to invoke a first feature value of the preset first unlocking point within predetermined duration after the second receiving unit 43 receives the unlock trigger instruction, where the first feature value is position coordinates of the first unlocking point on the screen. For a specific implementation manner, refer to step 202 in FIG. 2, which is not described herein again.

The first invoking unit 44 is further configured to invoke the first unlocking manner if the first feature value is invoked successfully within the predetermined duration. For a specific implementation manner, refer to step 203 in FIG. 2, which is not described herein again.

Further, the first invoking unit 44 is further configured to:

if the first feature value is not invoked successfully within the predetermined duration, invoke another unlocking manner that is preset in the touch-sensitive device and that is other than the first unlocking manner, so that the touch-sensitive device unlocks itself if the second unlocking manner is the same as the another unlocking manner. For a specific implementation manner, refer to step 204 in FIG. 2, which is not described herein again.

Optionally, that the unlocking feature is position-related includes that:

the unlocking feature is one or more second unlocking points or one first unlocking path, which is preset by the user on an image feature according to the image feature on a background picture, where the background picture is imported in advance by the user to serve as a screen background of the touch-sensitive device.

The first unlocking manner is tapping the one or more second unlocking points, or drawing a track by sliding along the first unlocking path.

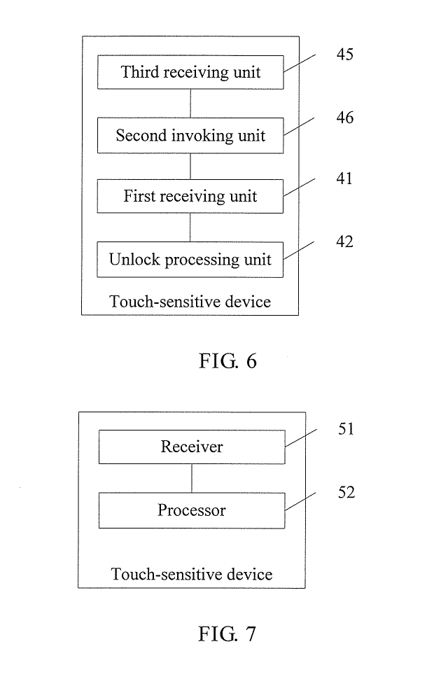

Further, as shown in FIG. 6, the touch-sensitive device further includes the third receiving unit 45 and the second invoking unit 46.

The third receiving unit 45 is configured to receive an unlock trigger instruction input by the user. For a specific implementation manner, refer to step 301 in FIG. 3, which is not described herein again.

The second invoking unit 46 is configured to invoke a second feature value of the preset second unlocking point or a third feature value of the first unlocking path within predetermined duration after the unlock trigger instruction is received, where the second feature value is position coordinates of the second unlocking point on the background picture, and the third feature value is position coordinates of points through which the first unlocking path passes on the background picture. For a specific implementation manner, refer to step 302 in FIG. 3, which is not described herein again.

The second invoking unit 46 is further configured to: if the second feature value or the third feature value is invoked successfully within the predetermined duration, display the background picture and invoke the first unlocking manner. For a specific implementation manner, refer to step 303 in FIG. 3, which is not described herein again.

Further, the second invoking unit 46 is further configured to:

if neither the second feature value nor the third feature value is invoked successfully within the predetermined duration, invoke another unlocking manner that is preset in the touch-sensitive device and that is other than the first unlocking manner, so that the touch-sensitive device unlocks itself if the second unlocking manner is the same as the another unlocking manner. For a specific implementation manner, refer to step 304 in FIG. 3, which is not described herein again.

According to a touch-sensitive device provided by this embodiment of the present invention, the touch-sensitive device receives a second unlocking manner input by a user; and the touch-sensitive device unlocks itself if the second unlocking manner is the same as a first unlocking manner. Because the first unlocking manner is preset by the user according to an unlocking feature, and the unlocking feature is position-related and is preset by the user, the unlocking feature may be updated according to a requirement of the user, so as to avoid a problem that the user always performs unlocking by inputting a default password or by using a default preset graphical interaction interface, which is monotonous and uninteresting.

As shown in FIG. 7, a touch-sensitive device provided by another embodiment of the present invention includes a receiver 51 and a processor 52.

The receiver 51 is configured to receive a second unlocking manner input by a user. For a specific implementation manner, refer to step 101 in FIG. 1, which is not described herein again.

The processor 52 is configured to unlock the touch-sensitive device if the second unlocking manner received by the receiver 51 is the same as a first unlocking manner. For a specific implementation manner, refer to step 102 in FIG. 1, which is not described herein again.

The first unlocking manner is preset by the user according to an unlocking feature, and the unlocking feature is position-related and is preset by the user. For a specific implementation manner, refer to step 102 in FIG. 1, which is not described herein again.

Optionally, that the unlocking feature is position-related includes that:

the unlocking feature is a first unlocking point preset by the user at one or more corners of a screen according to a shape of the screen of the touch-sensitive device, where each corner of the one or more corners is corresponding to one first unlocking point.

The first unlocking manner is tapping one or more of the preset first unlocking points.

Further, as shown in FIG. 7:

the receiver 51 is further configured to receive an unlock trigger instruction input by the user; for a specific implementation manner, refer to step 201 in FIG. 2, which is not described herein again;

the processor 52 is further configured to invoke a first feature value of the preset first unlocking point within predetermined duration after the receiver 51 receives the unlock trigger instruction, where the first feature value is position coordinates of the first unlocking point on the screen; for a specific implementation manner, refer to step 202 in FIG. 2, which is not described herein again; and

the processor 52 is further configured to invoke the first unlocking manner if the first feature value is invoked successfully within the predetermined duration; for a specific implementation manner, refer to step 203 in FIG. 2, which is not described herein again.

The processor 52 is further configured to:

if the first feature value is not invoked successfully within the predetermined duration, invoke another unlocking manner that is preset in the touch-sensitive device and that is other than the first unlocking manner, so that the touch-sensitive device unlocks itself if the second unlocking manner is the same as the another unlocking manner. For a specific implementation manner, refer to step 204 in FIG. 2, which is not described herein again.

Optionally, that the unlocking feature is position-related includes that:

the unlocking feature is one or more second unlocking points or one first unlocking path, which is preset by the user on an image feature according to the image feature on a background picture, where the background picture is imported in advance by the user to serve as a screen background of the touch-sensitive device.

The first unlocking manner is tapping the one or more second unlocking points, or drawing a track by sliding along the first unlocking path.

Further, as shown in FIG. 7, the receiver 51 is configured to receive an unlock trigger instruction input by the user. For a specific implementation manner, refer to step 301 in FIG. 3, which is not described herein again.

The processor 52 is configured to invoke a second feature value of the preset second unlocking point or a third feature value of the first unlocking path within predetermined duration after the unlock trigger instruction is received, where the second feature value is position coordinates of the second unlocking point on the background picture, and the third feature value is position coordinates of points through which the first unlocking path passes on the background picture. For a specific implementation manner, refer to step 302 in FIG. 3, which is not described herein again.

The processor 52 is further configured to: if the second feature value or the third feature value is invoked successfully within the predetermined duration, display the background picture and invoke the first unlocking manner. For a specific implementation manner, refer to step 303 in FIG. 3, which is not described herein again.

The processor 52 is further configured to:

if neither the second feature value nor the third feature value is invoked successfully within the predetermined duration, invoke another unlocking manner that is preset in the touch-sensitive device and that is other than the first unlocking manner, so that the touch-sensitive device unlocks itself if the second unlocking manner is the same as the another unlocking manner. For a specific implementation manner, refer to step 304 in FIG. 3, which is not described herein again.

According to a touch-sensitive device provided by another embodiment of the present invention, the touch-sensitive device receives a second unlocking manner input by a user; and the touch-sensitive device unlocks itself if the second unlocking manner is the same as a first unlocking manner. Because the first unlocking manner is preset by the user according to an unlocking feature, and the unlocking feature is position-related and is preset by the user, the unlocking feature may be updated according to a requirement of the user, so as to avoid a problem that the user always performs unlocking by inputting a default password or by using a default preset graphical interaction interface, which is monotonous and uninteresting.

From the foregoing descriptions of the embodiments, a person skilled in the art may clearly understand that the present invention may be implemented by software in addition to necessary universal hardware or by hardware only. In most circumstances, the former is an exemplary implementation. Based on such an understanding, the technical solutions of the present invention essentially or the part contributing to the prior art may be implemented in a form of a software product. The software product is stored in a readable storage medium, such as a floppy disk, a hard disk or an optical disc of a computer, and includes several instructions for instructing a computer device (which may be a personal computer, a server, or a network device) to perform the methods described in the embodiments of the present invention.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for unlocking a touch-sensitive device, the method comprising:
receiving, by the touch-sensitive device, a second unlocking manner input by a user; and
unlocking the touch-sensitive device if the second unlocking manner is the same as a first unlocking manner, wherein the first unlocking manner is preset by the user according to an unlocking feature, and the unlocking feature is position-related and is preset by the user.

2. The method according to claim 1, wherein:
the position-related unlocking feature comprises a first unlocking point preset by the user at one or more corners of a screen according to a shape of the screen of the touch-sensitive device, wherein each corner of the one or more corners is corresponding to one first unlocking point; and
the first unlocking manner comprises tapping one or more of the preset first unlocking points.

3. The method according to claim 2, wherein before receiving, by the touch-sensitive device, a second unlocking manner input by a user, the method further comprises:
receiving, by the touch-sensitive device, an unlock trigger instruction input by the user;
invoking, by the touch-sensitive device within predetermined duration, a first feature value of the preset first unlocking point after the unlock trigger instruction is received, wherein the first feature value is position coordinates of the first unlocking point on the screen; and
if the first feature value is invoked within the predetermined duration, invoking, by the touch-sensitive device, the first unlocking manner.

4. The method according to claim 3, further comprising:
if the first feature value is not invoked within the predetermined duration, invoking, by the touch-sensitive device, another unlocking manner that is preset in the touch-sensitive device and that is other than the first unlocking manner, so that the touch-sensitive device unlocks itself if the second unlocking manner is the same as the another unlocking manner.

5. The method according to claim 1, wherein:
the position-related unlocking feature comprises one or more second unlocking points or one first unlocking path, which is preset by the user on an image feature according to the image feature on a background picture, wherein the background picture is imported in advance by the user to serve as a screen background of the touch-sensitive device; and
the first unlocking manner comprises tapping the one or more second unlocking points, or drawing a track by sliding along the first unlocking path.

6. The method according to claim 5, wherein before receiving, by the touch-sensitive device, a second unlocking manner input by a user, the method further comprises:
receiving, by the touch-sensitive device, an unlock trigger instruction input by the user;
invoking, by the touch-sensitive device within predetermined duration, a second feature value of the preset second unlocking point or a third feature value of the first unlocking path after the unlock trigger instruction is received, wherein the second feature value is position coordinates of the second unlocking point on the background picture, and the third feature value is position coordinates of points through which the first unlocking path passes on the background picture; and
if the second feature value or the third feature value is invoked within the predetermined duration, displaying the background picture and invoking the first unlocking manner by the touch-sensitive device.

7. The method according to claim 6, further comprising:
if neither the second feature value nor the third feature value is invoked within the predetermined duration, invoking, by the touch-sensitive device, another unlocking manner that is preset in the touch-sensitive device and that is other than the first unlocking manner, so that the touch-sensitive device unlocks itself if the second unlocking manner is the same as the another unlocking manner.

8. A touch-sensitive device, comprising:
a first receiving unit, configured to receive a second unlocking manner input by a user; and
an unlock processing unit, configured to unlock the touch-sensitive device if the second unlocking manner received by the first receiving unit is the same as a first unlocking manner, wherein the first unlocking manner is preset by the user according to an unlocking feature, and the unlocking feature is position-related and is preset by the user.

9. The touch-sensitive device according to claim 8, wherein:
the position-related unlocking feature comprises a first unlocking point preset by the user at one or more corners of a screen according to a shape of the screen of the touch-sensitive device, wherein each corner of the one or more corners is corresponding to one first unlocking point; and
the first unlocking manner comprises tapping one or more of the preset first unlocking points.

10. The touch-sensitive device according to claim 9, further comprising:
a second receiving unit, configured to receive an unlock trigger instruction input by the user; and
a first invoking unit, configured to:
invoke a first feature value of the preset first unlocking point within predetermined duration after the second receiving unit receives the unlock trigger instruction, wherein the first feature value is position coordinates of the first unlocking point on the screen, and
invoke the first unlocking manner if the first feature value is invoked within the predetermined duration.

11. The touch-sensitive device according to claim 10, wherein the first invoking unit is further configured to:
if the first feature value is not invoked within the predetermined duration, invoke another unlocking manner that is preset in the touch-sensitive device and that is other than the first unlocking manner, so that the touch-sensitive device unlocks itself if the second unlocking manner is the same as the another unlocking manner.

12. The touch-sensitive device according to claim 8, wherein:
the position-related unlocking feature comprises one or more second unlocking points or one first unlocking path, which is preset by the user on an image feature according to the image feature on a background picture, wherein the background picture is imported in advance by the user to serve as a screen background of the touch-sensitive device; and
the first unlocking manner comprises tapping the one or more second unlocking points, or drawing a track by sliding along the first unlocking path.

13. The touch-sensitive device according to claim 12, further comprising:
a third receiving unit, configured to receive an unlock trigger instruction input by the user; and
a second invoking unit, configured to:
invoke a second feature value of the preset second unlocking point or a third feature value of the first unlocking path within predetermined duration after the unlock trigger instruction is received, wherein the second feature value is position coordinates of the second unlocking point on the background picture, and the third feature value is position coordinates of points through which the first unlocking path passes on the background picture, and
if the second feature value or the third feature value is invoked within the predetermined duration, display the background picture and invoke the first unlocking manner.

14. The touch-sensitive device according to claim 13, wherein the second invoking unit is further configured to:
if neither the second feature value nor the third feature value is invoked within the predetermined duration, invoke another unlocking manner that is preset in the touch-sensitive device and that is other than the first unlocking manner, so that the touch-sensitive device unlocks itself if the second unlocking manner is the same as the another unlocking manner.
